(19) United States
(12) Patent Application Publication
(10) Pub. No.: US 2009/0141903 A1
(43) Pub. Date: Jun. 4, 2009

(54) SOUND IMAGE LOCALIZATION APPARATUS

(75) Inventors: Yasuhito Watanabe, Kanagawa (JP); Atsunobu Murase, Kanagawa (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Kadoma-shi, Osaka (JP)

(21) Appl. No.: 11/719,383

(22) PCT Filed: Nov. 11, 2005
(86) PCT No.: PCT/JP2005/020714

§ 371 Date: May 15, 2007

(30) Foreign Application Priority Data
Nov. 24, 2004 (JP) 2004-339200
Nov. 10, 2005 (JP) 2005-325847

(51) Int. Cl. H04R 5/00

(52) U.S. Cl. 381/17

(57) ABSTRACT

The present invention provides a sound image localization apparatus capable of localizing a sound image at an intended sound image location unaffected by the physical feature of the listener.

The sound image localization apparatus comprises filter coefficient storage means (4) for storing therein candidates of filter coefficients, filter coefficient selection means (5) for selecting filter coefficients from among the candidates of the filter coefficients stored in the filter coefficient storage means (4), and sound image localization means (6) for performing filter processing to a sound signal on the basis of the filter coefficients selected by the filter coefficient selection means (5) to localize a sound image of a sound reproduced in accordance with the sound signal. The filter coefficient selection means (5) is operative to select the filter coefficients based on location information indicative of a location at which the sound image is localized and listener information indicative of the physical feature of the listener.

### TECHNICAL FIELD

The present invention relates to a sound image localization apparatus, and more particularly to a sound image localization apparatus for three-dimensionally localizing a sound image of a sound reproduced from speakers or headphones of a mobile terminal.

### BACKGROUND ART

The conventional sound image localization apparatus of this type is shown in FIG. 12 as comprising input terminals 71 to 74 having respective sound signals inputted therethrough from respective channels for a left-front sound source (LF), right-front sound source (RF), left-back sound source (LB), and right-back sound source (RB), analog-to-digital (AD) converters 75 to 78 for performing AD conversions to the respective sound signals to convert from analog to digital, a signal processor 79 constituted by FIR (Finite Impulse Response) filters each for actualizing an impulse response indicative of a transfer characteristic preliminarily measured or calculated from each of the sound sources to each of positions of ears, a tap number selector 80 for selecting the tap numbers of the FIR filters, digital-to-analog (DA) converters 81R and 81L for performing DA conversions to the respective sound signals to convert from digital to analog for left and right channels, power amplifiers 82R and 82L for amplifying the power of the respective sound signals of left and right channels, and left and right speakers 83L and 83R of a headphone unit 83 for outputting the respective sound signals of the left and right channels. In the conventional sound image localization apparatus thus constructed, the signal processor 79 is operative to localize sound images of the sounds respectively reproduced in accordance with the sound signals from the left and right speakers 83L and 83R (see, for example, Patent Document 1).

Patent Document 1: Japanese Patent Laid-Open Publication 2002-112399 (page 6 and FIG. 1)

### DISCLOSURE OF INVENTION

### Problem to be Solved by the Invention

However, the length of time and the frequency characteristic between the reproduction of the sound from the speaker and the arrival of the sound at the listener's ear depend upon the physical feature such as the size of the head of the listener. The conventional sound image localization apparatus, therefore, encounters such a problem that the sound image is liable to be localized at an unintended sound image location dependent upon the physical feature of the listener.

It is, therefore, an object of the present invention to provide a sound image localization apparatus which can localize the sound image at the intended sound image location unaffected by the physical feature of the listener.

### Means for Resolving the Problem

According to one aspect of the present invention, there is provided a sound image localization apparatus, comprising: filter coefficient storage means for storing therein candidates of filter coefficients; filter coefficient selection means for selecting filter coefficients from among the candidates of the filter coefficients stored in the filter coefficient storage means; and sound image localization means for performing filter processing to a sound signal on the basis of the filter coefficients selected by the filter coefficient selection means to localize a sound image of a sound reproduced in accordance with the sound signal, in which the filter coefficient selection means is operative to select the filter coefficients based on location information indicative of a location at which the sound image is localized and listener information indicative of a physical feature of a listener.

In accordance with the above construction, the sound image localization apparatus according to the present invention is designed to select the filter coefficients of the filter processing based on the listener information indicative of the physical feature of the listener in addition to the location information. The sound image localization apparatus can therefore localize the sound images at the intended sound image locations unaffected by the physical feature of the listener.

The sound image localization apparatus may further comprise listener information storage means for storing therein the listener information. The sound image localization apparatus may further comprise registered listener information input means for inputting the listener information to be stored in the listener information storage means.

In accordance with the above construction, the sound image localization apparatus according to the present invention is designed to select the filter coefficients of the filter processing based on the listener information stored in the listener information storage means. The sound image localization apparatus can therefore localize the sound images at intended sound image locations unaffected by the physical feature of the listener.

According to another aspect of the present invention, there is provided a sound image localization apparatus, comprising: filter coefficient storage means for storing therein candidates of filter coefficients suitable for a physical feature of a listener; filter coefficient selection means for selecting filter coefficients from among the candidates of the filter coefficients stored in the filter coefficient storage means; and sound image localization means for performing filter processing to a sound signal on the basis of the filter coefficients selected by the filter coefficient selection means to localize a sound image of a sound reproduced in accordance with the sound signal, in which the filter coefficient selection means is operative to select the filter coefficients based on location information indicative of a location at which the sound image is localized.

In accordance with the above construction, the sound image localization apparatus according to the present invention is designed to select the filter coefficients of the filter processing based on the listener information suitable for the physical feature of the listener. The sound image localization apparatus can therefore localize the sound images at intended sound image locations unaffected by the physical feature of the listener.

The sound image localization apparatus according to the present invention limits the candidates of the filter coefficients stored in the filter coefficient storage means to the filter coefficients suitable for the physical feature of the listener. The sound image localization apparatus can therefore reduce the required storage capacity of the filter coefficient storage means and the operation time of selecting the filter coefficients.

The sound image localization apparatus may further comprise filter coefficient registration means for registering the candidates of the filter coefficients suitable for the physical feature of the listener into the filter coefficient storage means.

In accordance with the above construction, the sound image localization apparatus according to the present invention can register the candidates of the filter coefficients suitable for the physical feature of the listener into the filter coefficient storage means.

The sound image localization apparatus may be connected to a filter coefficient storage apparatus via a network, in which the filter coefficient registration means is operative to send listener information indicative of the physical feature of the listener to the filter coefficient storage apparatus to receive from the filter coefficient storage apparatus the candidates of the filter coefficients to be registered into the filter coefficient storage means.

In accordance with the above construction, the sound image localization apparatus according to the present invention can obtain the candidates of the filer coefficients suitable for the physical feature of the listener from the filter coefficient storage apparatus connected via the network. The sound image localization apparatus can therefore register the obtained candidates of the filter coefficients into the filter coefficient storage means.

The sound image localization apparatus may further comprise listener information storage means for storing therein the listener information, in which the filter coefficient registration means is operative to send to the filter coefficient storage apparatus the listener information stored in the listener information storage means.

In accordance with the above construction, the sound image localization apparatus according to the present invention can obtain the candidates of the filer coefficients suitable for the preliminarily stored physical feature of the listener from the filter coefficient storage apparatus connected via the network. The sound image localization apparatus can therefore register the obtained candidates of the filter coefficients into the filter coefficient storage means.

The sound image localization apparatus may further comprise listener information input means for inputting a part of the listener information, and listener information storage means for storing therein another part of the listener information, in which the filter coefficient registration means is operative to send to the filter coefficient storage apparatus the listener information constituted by the part of the listener information inputted from the listener information input means and the part of the listener information stored in the listener information storage means.

In accordance with the above construction, the sound image localization apparatus according to the present invention can obtain the candidates of the filer coefficients suitable for the preliminarily stored physical feature of the listener and for the physical feature of the listener inputted by the listener from the filter coefficient storage apparatus connected via the network. The sound image localization apparatus can therefore register the obtained candidates of the filter coefficients into the filter coefficient storage means.

The sound image localization apparatus may further comprise registered listener information input means for inputting the listener information to be stored in the listener information storage means.

In accordance with the above construction, the sound image localization apparatus according to the present invention can store the physical feature of the listener in the listener information storage means.

The sound image localization apparatus may further comprise listener information input means for inputting the listener information, in which the filter coefficient registration means is operative to send to the filter coefficient storage apparatus the listener information inputted from the listener information input means.

In accordance with the above construction, the sound image localization apparatus according to the present invention can obtain the candidates of the filer coefficients suitable for the physical feature of the listener inputted by the listener from the filter coefficient storage apparatus connected via the network. The sound image localization apparatus can therefore register the obtained candidates of the filter coefficients into the filter coefficient storage means.

In the sound image localization apparatus according to the present invention, the physical feature of the listener may include at least one of a gender and height of the listener.

The sound image localization apparatus may further comprise storage medium holding means for holding a removable storage medium, and filter coefficient writing means for writing the candidates of the filter coefficients stored in the filter coefficient storage means into the storage medium held by the storage medium holding means.

In accordance with the above construction, the sound image localization apparatus according to the present invention can write the candidates of the filter coefficients stored in the filter coefficient storage means into the storage medium. The sound image localization apparatus can therefore make other sound image localization apparatus utilize the candidates of the filter coefficients stored in the filter coefficient storage means.

The sound image localization apparatus may further comprise filter coefficient reading means for reading the candidates of the filter coefficients to be stored in the filter coefficient storage means from the storage medium held by the storage medium holding means.

In accordance with the above construction, the sound image localization apparatus according to the present invention can read the candidates of the filter coefficients from the storage medium into the filter coefficient storage means. The sound image localization apparatus can therefore utilize the candidates of the filter coefficients stored in the other sound image localization apparatus.

### EFFECTS OF THE INVENTION

The present invention provides the sound image localization apparatus having effects to localize the sound image at the intended sound image location unaffected by the physical feature of the listener, and make the listener set the filter coefficients suitable for the listener without any difficulty.

### BRIEF DESCRIPTION OF THE DRAWINGS

FIG. 1 is a block diagram showing a first preferred embodiment of the sound image localization apparatus according to the present invention.

FIG. 2 is a block diagram showing sound image localization means constituting the first preferred embodiment of the sound image localization apparatus according to the present invention.

FIG. 3 is a diagram to explain candidates of filter coefficients stored in filter coefficient storage means constituting the first preferred embodiment of the sound image localization apparatus according to the present invention.

FIG. 4 is an image of a selection window to select location information for filter coefficient selection means constituting the first preferred embodiment of the sound image localization apparatus according to the present invention.

FIG. 5 is a flow chart to explain the operation of the first preferred embodiment of the sound image localization apparatus according to the present invention.

FIG. 6 is a block diagram showing a second preferred embodiment of the sound image localization apparatus according to the present invention.

FIG. 7 is a diagram to explain candidates of filter coefficients stored in filter coefficient storage means constituting the second preferred embodiment of the sound image localization apparatus according to the present invention.

FIG. 8 is a flow chart to explain the operation of the second preferred embodiment of the sound image localization apparatus according to the present invention.

FIG. 9 is a block diagram showing a first modified form of the second preferred embodiment of the sound image localization apparatus according to the present invention.

FIG. 10 is a block diagram showing a second modified form of the second preferred embodiment of the sound image localization apparatus according to the present invention.

FIG. 11 is a block diagram showing a third preferred embodiment of the sound image localization apparatus according to the present invention.

FIG. 12 is a block diagram showing the conventional sound image localization apparatus.

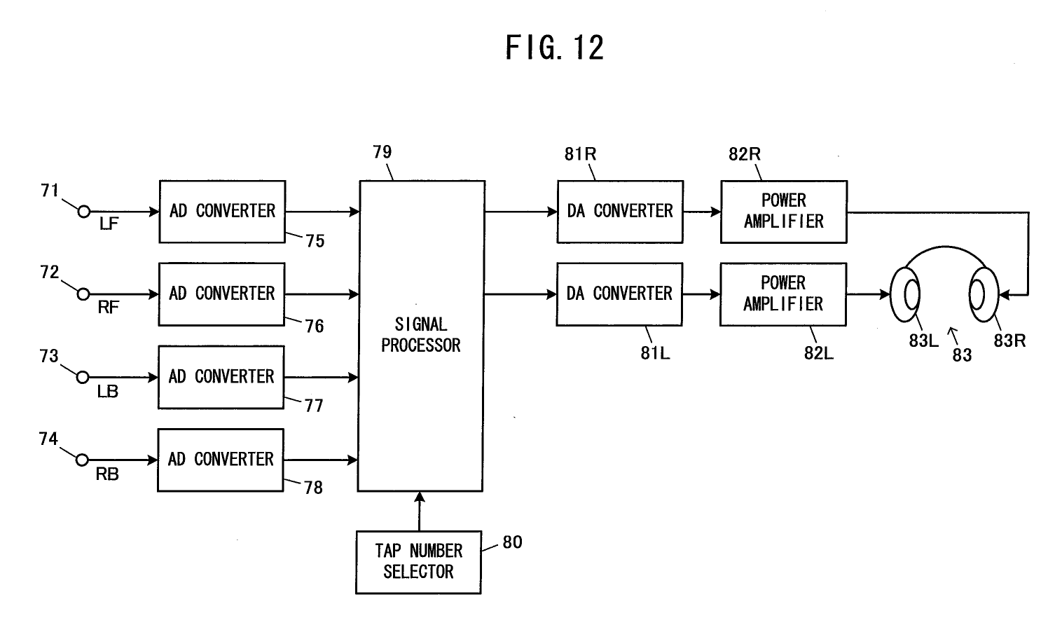

### EXPLANATION OF REFERENCE NUMERALS

1, 40, 60 sound image localization apparatus
2 registered listener information input means
3 listener information storage means
4, 41 filter coefficient storage means
5, 43 filter coefficient selection means
6 sound image localization means
7L, 7R, 81L, 81R DA converter
8L, 8R, 82L, 82R power amplifier
9, 93 headphone unit
9L, 83L left speaker
9R, 83R right speaker
11, 12, 13, 14, 15, 16, 17, 18 FIR filter
19, 20, 21, 22, 23, 24 adder
42 filter coefficient registration means
44 listener information input means
45 network
46 filter coefficient storage apparatus
61 storage medium holding means
62 filter coefficient writing means
63 filter coefficient reading means
71, 72, 73, 74 input terminal
75, 76, 77, 78 AD converter
79 signal processor
80 tap number selector

### DESCRIPTION OF THE PREFERRED EMBODIMENTS

The preferred embodiments of the present invention will be described hereinafter with reference to the drawings.

### First Preferred Embodiment

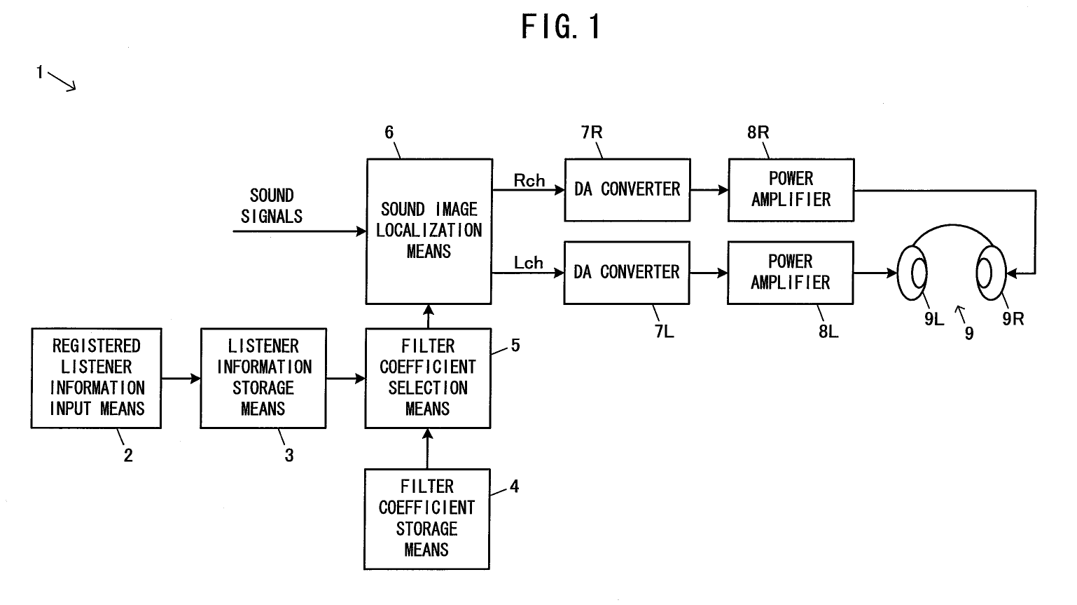

The first preferred embodiment according to the present invention is shown in FIG. 1.

In FIG. 1, the sound image localization apparatus 1 comprises registered listener information input means 2 for inputting listener information indicative of the physical feature of the listener, listener information storage means 3 for storing therein the listener information, filter coefficient storage means 4 for storing therein candidates of filter coefficients, filter coefficient selection means 5 for selecting filter coefficients from among the candidates of the filter coefficients stored in the filter coefficient selection means 4, sound image localization means 6 for performing filter processing to digital sound signals inputted into the sound image localization apparatus 1 to localize sound images of sounds reproduced in accordance with the sound signals, DA converters 7L and 7R for performing DA conversions to the respective sound signals filtered by the filter processing of the sound image localization means 6 for a left channel (hereinafter simply referred to as “Lch”) and a right channel (hereinafter simply referred to as “Rch”), power amplifiers 8L and 8R for amplifying the power of the respective sound signals of the Lch and Rch, and a headphone unit 9 having left and right speakers 9L and 9R for outputting the respective sound signals from the Lch and Rch.

There is a size of the listener's head as it has an influence on the length of time between the reproduction of the sound and the arrival of the sound at the listener's ear. A mean value of size of the head of the human varies depending upon gender, and the mean value of men tends to be greater than that of women. The mean value of size of the head of the human also varies depending upon height, and the mean value of tall persons tends to be greater than that of short persons.

The physical feature of the listener includes the gender and height of the listener in this embodiment, while the physical feature of the listener may include at least one of the gender and height of the listener in the present invention.

The registered listener information input means 2 is constituted by an input device such as a keyboard device. The listener information storage means 3 and the filter coefficient storage means 4 are collectively constituted by a nonvolatile storage medium such as a hard disc or flash memory. There have been many terminal devices, such as mobile-phones, having the function to register personal information into a storage medium inside the terminal device. The listener information storage means 3 may be constituted by the storage medium registering preliminarily the listener information as the personal information inside the terminal device in the case where the sound image localization apparatus 1 is applied to the above-mentioned terminal device. In this case, the personal information registered in an old terminal device can be transferred to a new terminal device by communication functions of the terminal devices, whereby it is realizable to write the listener information into the listener information storage means of the new terminal device.

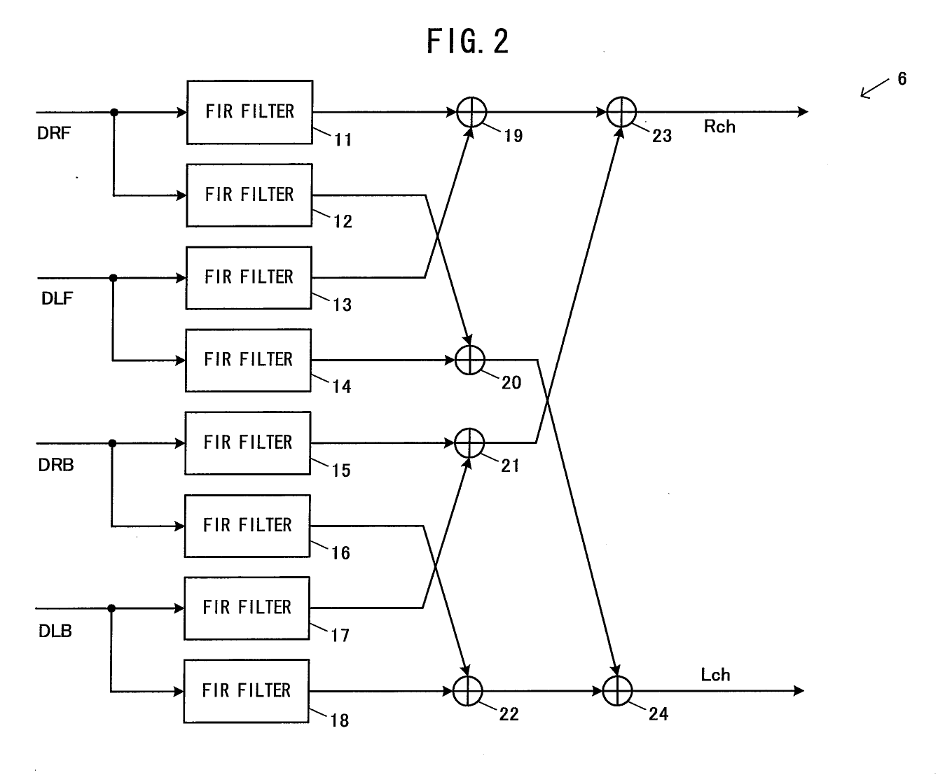

The sound image localization means 6 has the construction depending upon the number of the channels for the sound signals operated by the sound image localization apparatus 1. The sound image localization means 6 is constructed as shown in FIG. 2 for example where the sound signals are assigned to 4 channels for a left-front sound source (DLF), right-front sound source (DRF), left-back sound source (DLB), and right-back sound source (DRB).

In FIG. 2, the sound image localization means 6 comprises FIR filters 11 and 12 for performing filter processing to the sound signal of the channel DRF, FIR filters 13 and 14 for performing filter processing to the sound signal of the channel DLF, FIR filters 15 and 16 for performing filter processing to the sound signal of the channel DRB, FIR filters 17 and 18 for performing filter processing to the sound signal of the channel DLB, an adder 19 for adding the sound signals respectively filtered by the filter processing of FIR filters 11 and 13, an adder 20 for adding the sound signals respectively filtered by the filter processing of FIR filters 12 and 14, an adder 21 for adding the sound signals respectively filtered by the filter processing of FIR filters 15 and 17, an adder 22 for adding the sound signals respectively filtered by the filter processing of FIR filters 16 and 18, an adder 23 for adding the sound signals respectively added by the adder 19 and 21, and an adder 24 for adding the sound signals respectively added by the adder 20 and 22.

The sound image localization means 6 is designed to output the sound signal added by the adder 23 for the Rch and the sound signal added by the adder 24 for the Lch.

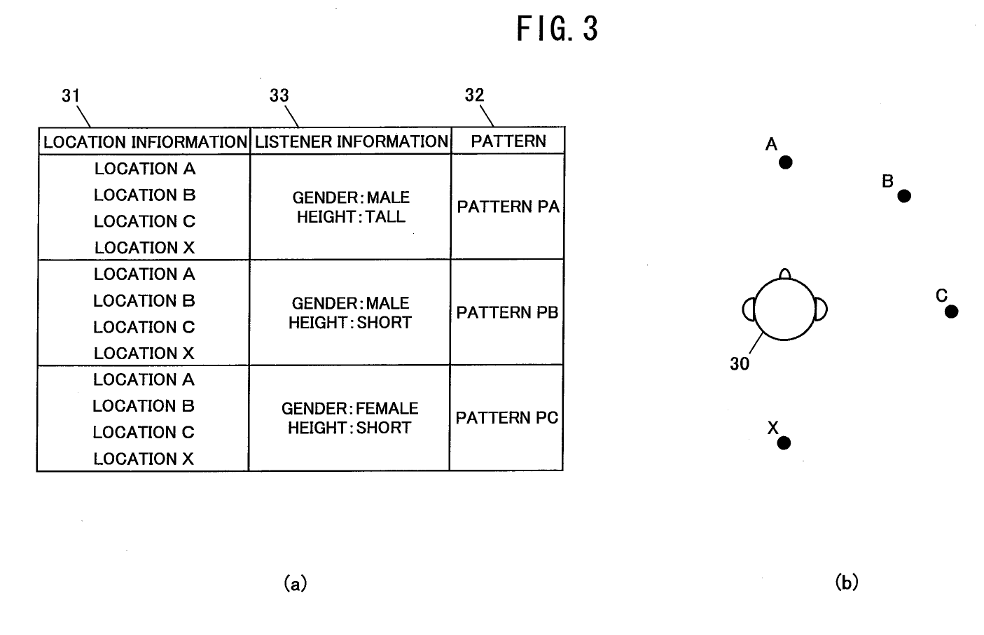

As shown in FIG. 3(a), the filter coefficient storage means 4 relationally stores therein location information 31 indicative of locations at which the sound images are localized, the candidates of the filter coefficients (hereinafter simply referred to as “patterns”) 32, and the listener information 33.

In the case as shown in FIG. 3(b), where the sound images are intended to be localized at respective locations “A”, “B”, “C”, and “X” with respect to the listener 30, the filter coefficient selection means 5 is operative to select a single pattern from among the patterns 32 stored in the filter coefficient storage means 4 based on the location information indicative of the locations “A”, “B”, “C”, and “X” and the listener information.

The filter coefficient selection means 5 is, for example, operative to select the pattern PA when the listener information stored in the listener information storage means 3 indicates that the listener 30 is a tall man, and operative to select the pattern PC when the listener information stored in the listener information storage means 3 indicates that the listener 30 is a short woman.

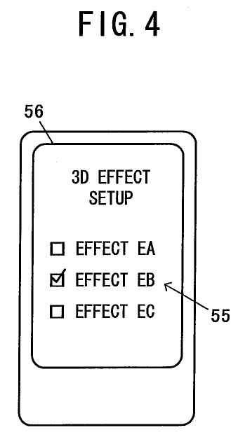

As shown in FIG. 4, the filter coefficient selection means 5 may be operative to output candidates of the listener information 55 to a display device 56, such as a liquid crystal display device, so as to make the listener select the listener information via an input device, such as a pointing device.

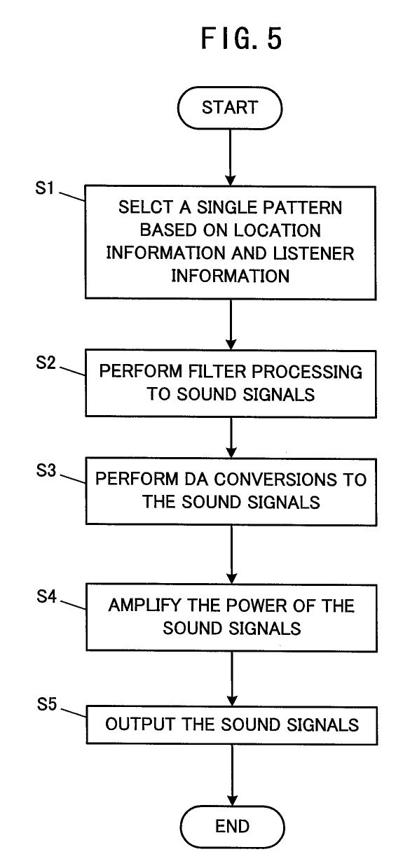

The sound image localization operation of the sound image localization apparatus 1 constructed as previously mentioned will be described hereinafter with reference to FIG. 5.

Under the state that the listener information inputted from the registered listener information input means 2 is stored in the listener information storage means 3, the single pattern is firstly selected by the filter coefficient selection means 5 from among the plurality of patterns stored in the filter coefficient storage means 4 based on the listener information and the location information indicating the location at which the sound images are localized (S1).

The digital sound signals inputted into the sound image localization apparatus 1 are then filtered by the filter processing of the sound image localization means 6 on the basis of the filter coefficients contained within the pattern selected by the filter coefficient selection means 5 (S2).

The sound signals filtered for the Lch and Rch by the filter processing of the sound image localization means 6 are then converted by the DA conversions of the respective DA converters 7L, 7R (S3). The power of the sound signals are then respectively amplified by the power amplifiers 8R and 8L (S4), and the sound signals are outputted by the left and right speakers 9L and 9R (S5).

As will be seen from the foregoing description, it is to be understood that the first preferred embodiment of the sound image localization apparatus 1 according to the present invention is designed to select the filter coefficients of the filter processing based on the listener information indicative of the physical feature of the listener in addition to the location information. The sound image localization apparatus 1 can therefore localize the sound images at the intended sound image locations unaffected by the physical feature of the listener. In addition, the sound image localization apparatus 1 is designed to obtain the listener information from the personal information registered in the terminal device in the case where the sound image localization apparatus 1 is applied to the terminal device, such as a mobile-phone. The sound image localization apparatus 1 can therefore prevent the sound images from being localized on the basis of preset filter coefficients not suited for the listener.

While there has been described in the foregoing embodiment about the fact that the sound image localization apparatus 1 comprises the headphone unit 9, the sound image localization apparatus 1 may comprise two speaker units instead of the headphone unit 9.

In the case where the sound image localization apparatus 1 comprises the speaker units, the filter coefficients stored in the filter coefficient storage means 4 is set in dependence upon the locations of the speaker units. In this case, the sound image localization apparatus 1 may further comprise filter coefficient registration means for setting the filter coefficients into the filter coefficient storage means 4 on the basis of information indicative of the locations of the speaker units.

### Second Preferred Embodiment

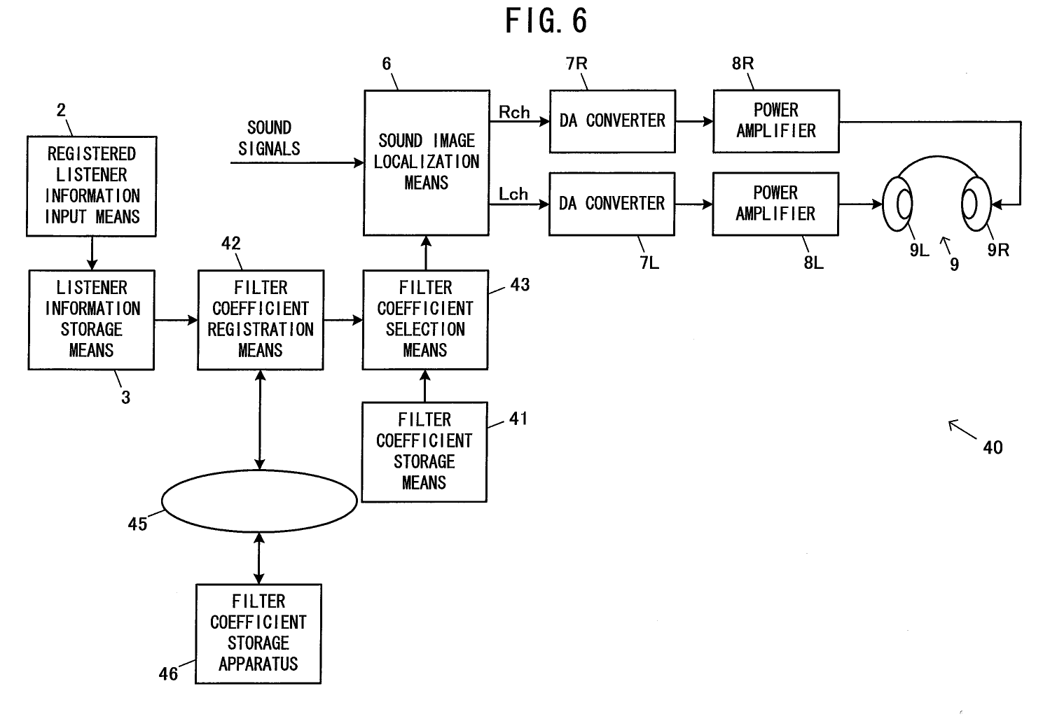

The second preferred embodiment of the sound image localization apparatus according to the present invention is shown in FIG. 6. The constitutional elements of this embodiment of the sound image localization apparatus 40 similar to those of the first preferred embodiment of the sound image localization apparatus 1 according to the present invention will be omitted from the following detailed description and identified by the common reference numerals.

As shown in FIG. 6, the sound image localization apparatus 40 comprises registered listener information input means 2, listener information storage means 3, filter coefficient storage means 41 for storing therein candidates of filter coefficients, filter coefficient registration means 42 for registering the candidates of the filter coefficients into the filter coefficient storage means 4 after obtaining the candidates of the filter coefficients suitable for the physical feature of the listener on the basis of the listener information stored in the listener information storage means 3, filter coefficient selection means 43 for selecting filter coefficients from among the candidates of the filter coefficients stored in the filter coefficient selection means 41, sound image localization means 6, DA converters 7L and 7R, power amplifiers 8R and 8L, and a headphone unit 9.

The filter coefficient registration means 42 is connected to a filter coefficient storage apparatus 46 via a network 45, and is operative to send the listener information stored in the listener information storage means 3 to the filter coefficient storage apparatus 46.

The filter coefficient storage apparatus 46 relationally stores therein physical features of listeners and the candidates of the filter coefficients suitable for the respective physical features. The filter coefficient storage apparatus 46 is designed to receive the listener information, and designed to send the candidates of the filter coefficients in relation to the received listener information via the network 45 to the sender of the received listener information.

The filter coefficient registration means 42 is operative to receive the candidates of the filter coefficients, and operative to register the received candidates of the filter coefficients into the filter coefficient storage means 41. In the case where the candidates of the filter coefficients are already stored in the filter coefficient storage means 41, the filter coefficient registration means 42 is operative to dispose the previously stored candidates of the filter coefficients before registering the received candidates of the filter coefficients.

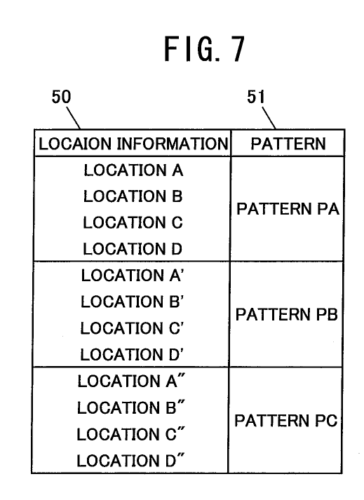

As shown in FIG. 7, the filter coefficient storage means 41 relationally stores therein location information 50 indicative of locations at which the sound images are localized, and the patterns 51. The filter coefficient selection means 43 is operative to select a single pattern from among the plurality of patterns stored in the filter coefficient storage means 41.

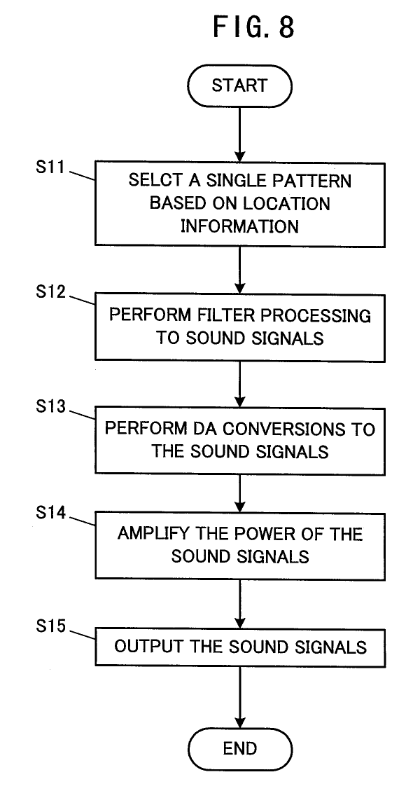

The sound image localization operation of the sound image localization apparatus 40 constructed as previously mentioned will be described hereinafter with reference to FIG. 8.

Under the state that the plurality of patterns obtained by the filter coefficient registration means 42 in accordance with the listener information are stored in the filter coefficient storage means 41, the single pattern is firstly selected by the filter coefficient selection means 43 based on the location information from among the plurality of patterns (S11).

The digital sound signals inputted into the sound image localization apparatus 40 are then filtered by the filter processing of the sound image localization means 6 on the basis of the filter coefficients contained within the pattern selected by the filter coefficient selection means 43 (S12).

The sound signals filtered for the Lch and Rch by the filter processing of the sound image localization means 6 are then converted by the DA conversions of the respective DA converters 7L, 7R (S13). The power of the sound signals are then respectively amplified by the power amplifiers 8R and 8L (S14), and the sound signals are outputted by the left and right speakers 9L and 9R (S15).

As will be seen from the foregoing description, it is to be understood that the second preferred embodiment of the sound image localization apparatus 40 according to the present invention is designed to select the filter coefficients of the filter processing from among the candidates of the filter coefficients suitable for the physical feature of the listener. The sound image localization apparatus 40 can therefore localize the sound images at intended sound image locations unaffected by the physical feature of the listener.

In addition, the second preferred embodiment of the sound image localization apparatus 40 according to the present invention limits the candidates of the filter coefficients stored in the filter coefficient storage means 41 to the filter coefficients suitable for the physical feature of the listener. The sound image localization apparatus 1 can therefore reduce the required storage capacity of the filter coefficient storage means 41.

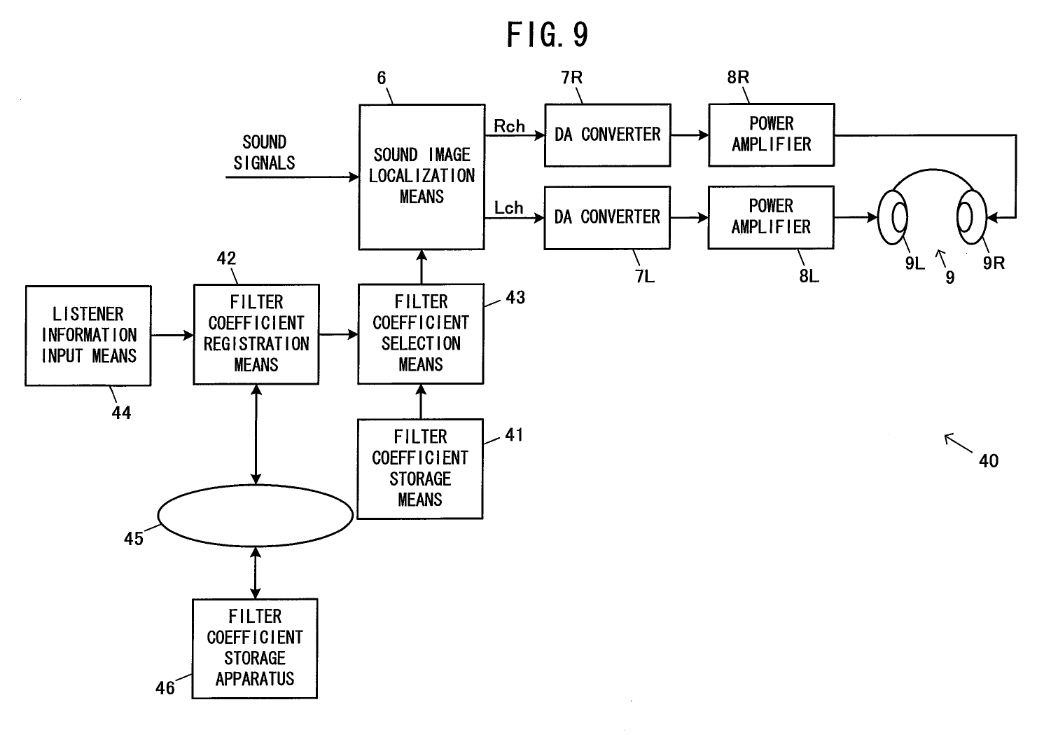

As shown in FIG. 9, the second preferred embodiment of the sound image localization apparatus 40 according to the present invention may comprise listener information input means 44 for inputting the listener information instead of the registered listener information input means 2 and the listener information storage means 3, and the filter coefficient registration means 42 may be operative to transmit to the filter coefficient storage apparatus 46 the listener information inputted from the listener information input means 44.

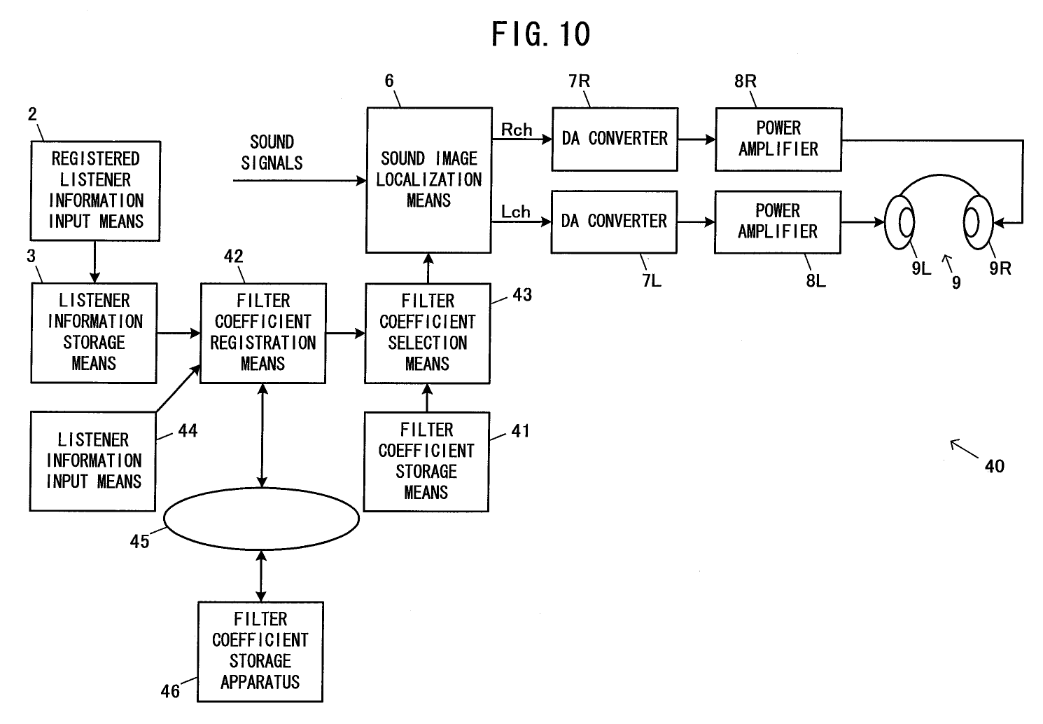

As shown in FIG. 10, the second preferred embodiment of the sound image localization apparatus 40 according to the present invention may further comprise listener information input means 44, and the filter coefficient registration means 42 may be operative to transmit to the filter coefficient storage apparatus 46 a part of the listener information inputted from the listener information input means 44 and another part of the listener information stored in the listener information storage means 3.

The sound image localization apparatus 40 constructed aforementioned may store the gender in the listener information storage means 3, and have the height inputted therein via the listener information input means 44.

The listener information input means 44 described above may use a user's answer to a query from the filter coefficient storage apparatus 46 via the network 45 as the whole or part of the listener information.

### Third Preferred Embodiment

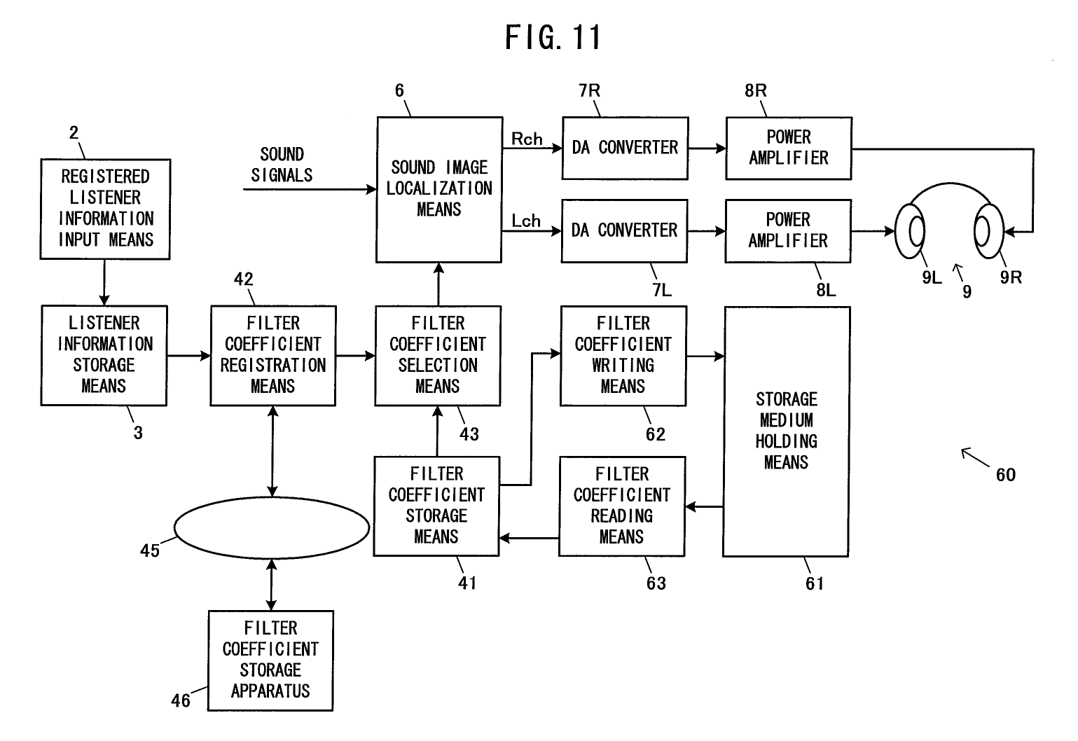

The third preferred embodiment of the sound image localization apparatus according to the present invention is shown in FIG. 11. The constitutional elements of this embodiment of the sound image localization apparatus 60 similar to those of the second preferred embodiment of the sound image localization apparatus 40 according to the present invention will be omitted from the following detailed description and identified by the common reference numerals.

As shown in FIG. 11, the sound image localization apparatus 60 comprises, in addition to the constitutional elements of the second preferred embodiment of the sound image localization apparatus 40 according to the present invention, storage medium holding means 61 for holding a removable storage medium, filter coefficient writing means 62 for writing the candidates of the filter coefficients stored in the filter coefficient storage means 41 into the storage medium held by the storage medium holding means 61, and filter coefficient reading means 63 for reading the candidates of the filter coefficients to be stored in the filter coefficient storage means 41 from the storage medium held by the storage medium holding means 61.

As for the removable storage medium held by the storage medium holding means 61, there is a memory card, such as for example an SD (Secure Digital) memory card, having a flash memory built therein, a magnetic disc, or an optical memory disc.

The sound image localization operation of the sound image localization apparatus 60 is similar to that of the second preferred embodiment of the sound image localization apparatus 40 according to the present invention described above with reference to FIG. 8. Therefore the operation of the sound image localization apparatus 60 will be omitted from the following description.

As will be seen from the foregoing description, it is to be understood that the third preferred embodiment of the sound image localization apparatus 60 according to the present invention is designed to write the candidates of the filter coefficients stored in the filter coefficient storage means 41 into the storage medium. The sound image localization apparatus 60 can therefore make other sound image localization apparatus utilize the candidates of the filter coefficients stored in the filter coefficient storage means 41.

In addition, the third preferred embodiment of the sound image localization apparatus 60 according to the present invention is designed to read the candidates of the filter coefficients from the storage medium into the filter coefficient storage means 41. The sound image localization apparatus 60 can therefore utilize the candidates of the filter coefficients stored in the other sound image localization apparatus.

### INDUSTRIAL APPLICABILITY

As will be seen from the above descriptions, the sound image localization apparatus according to the present invention has effects to localize the sound image at the intended sound image location unaffected by the physical feature of the listener, and to make the listener set the filter coefficients suitable for the listener without any difficulty. The sound image localization apparatus according to the present invention is therefore available to a sound image localization apparatus for three-dimensionally localizing the sound image of the sound reproduced from speakers or headphones of the mobile terminal.

1. A sound image localization apparatus provided in a personal terminal device, comprising:
filter coefficient storage means for storing therein candidates of filter coefficients;
filter coefficient selection means for selecting filter coefficients from among said candidates of said filter coefficients stored in said filter coefficient storage means; and
sound image localization means for performing filter processing to a sound signal on the basis of said filter coefficients selected by said filter coefficient selection means to localize a sound image of a sound reproduced in accordance with said sound signal, wherein
said filter coefficient selection means is operable to obtain listener information indicative of a physical feature of a listener from personal information preliminarily registered in said personal terminal device, and operable to select said filter coefficients based on location information and said listener information, said location information being indicative of a location at which said sound image is localized.

2. (canceled)

3. (canceled)

4. (canceled)

5. (canceled)

6. (canceled)

7. (canceled)

8. (canceled)

9. (canceled)

10. (canceled)

11. A sound image localization apparatus as set forth in claim 1, wherein said physical feature of said listener includes at least one of a gender and height of said listener.

12. (canceled)

13. (canceled)

14. A sound image localization apparatus as set forth in claim 1, wherein:
said personal terminal device is connectable to a server via an external network; and
said filter coefficients is obtained from said server via said personal terminal device on the basis of said listener.
